(19) United States
(12) Patent Application Publication
(10) Pub. No.: US 2014/0099608 A1
(43) Pub. Date: Apr. 10, 2014

(54) 2 AND 3 COLUMN COLOUR CHARTS (X/Y) AND (Y/X/Z) WITH STRUCTURE, NUMBERING AND TEMPLATES TO BE USED AS HARDCOPY AND SOFTWARE

(71) Applicant: DIANE MARGARET CROMPTON, Hastings (NZ)

(72) Inventor: DIANE MARGARET CROMPTON, Hastings (NZ)

(21) Appl. No.: 13/603,443

(22) Filed: Sep. 5, 2012

Related U.S. Application Data
(60) Provisional application No. 61/513,638, filed on Oct. 5, 2011.

(51) Int. Cl. G01J 3/52

(52) U.S. Cl. CPC G01J 3/52
USPC 434/98

(57) ABSTRACT

Design 1: 2-Column structured Colour Chart on a horizontal (x-axis) and vertical (y-axis) showing harmony and complementary colours. In Design 4: 3-Column structured Colour Chart (y,x,z) and (z,y,x) structured as a protein molecule, showing harmony, complementary, triad and tetrad combinations. These charts have a unique system of numbering and viewing colour, unlike other conventional chronological colour sequencing charts. It enables a repetitive patterned sequence of family colour groups to alternate at various levels allowing all colours to lie adjacent to each other and be viewed simultaneously revealing their vibrating relationships. The layout and numbering system allows for development as a tangible chart or software application, where they can be programmed into sequences allowing many charts, colours, templates, relationships to be viewed. The templates consolidate colour for education while businesses/manufacturers can replace with their colours and codes and use as a colour planner.

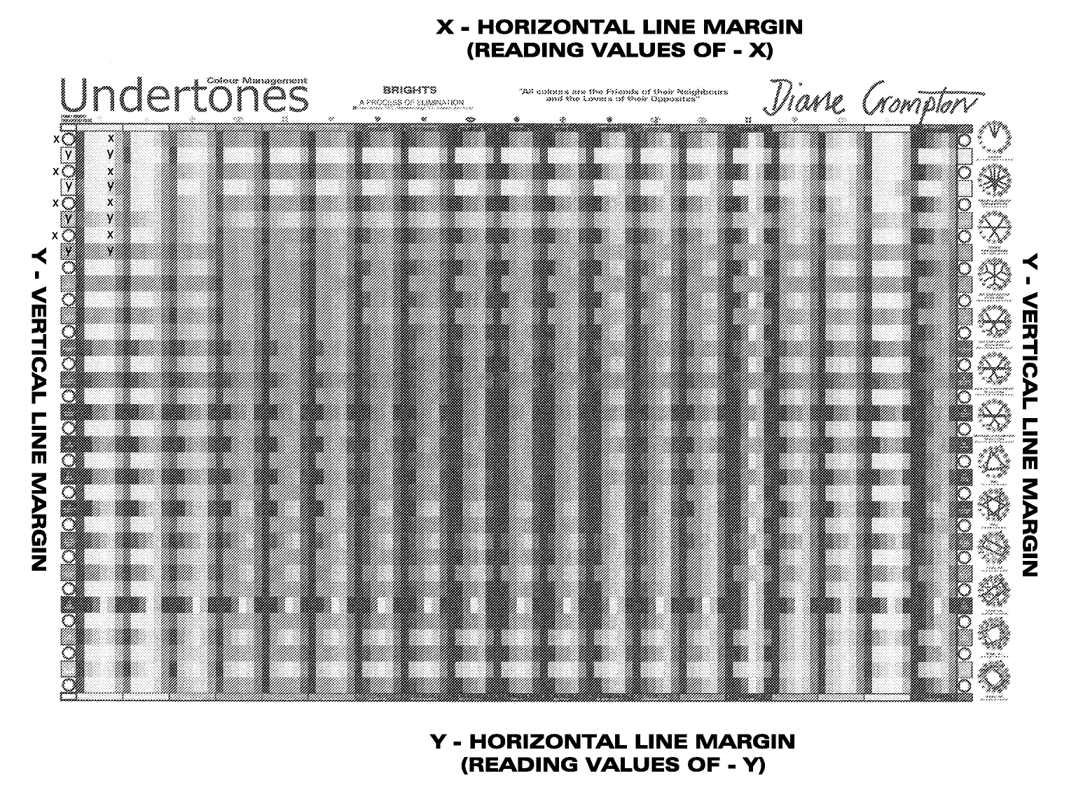

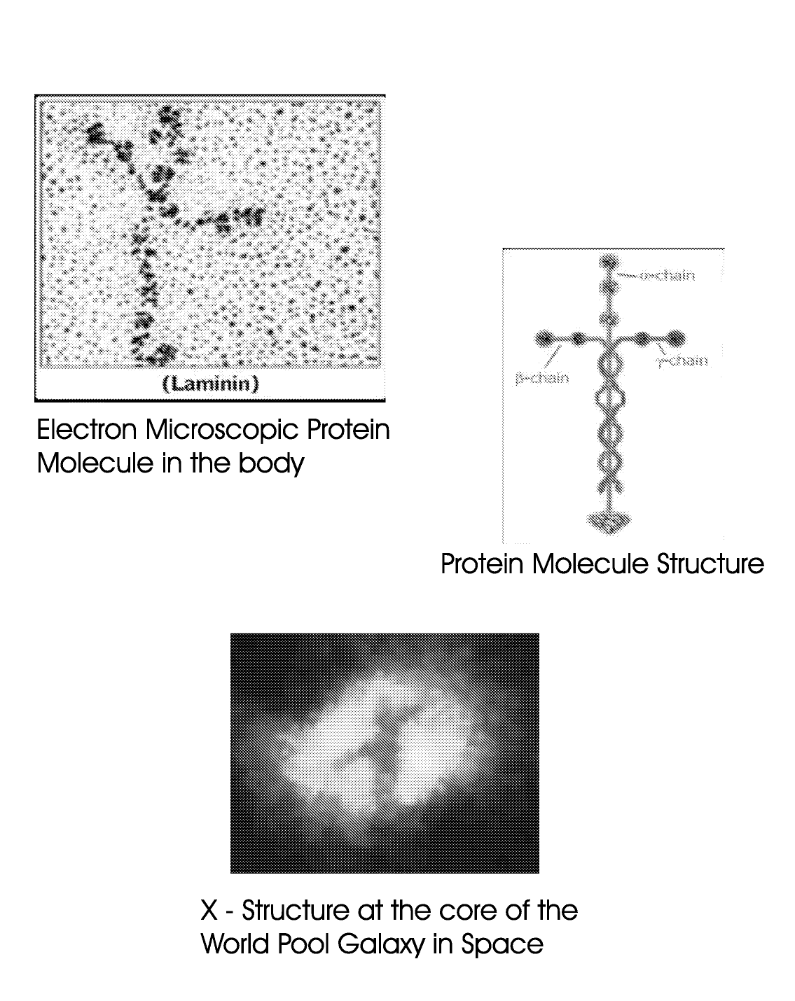

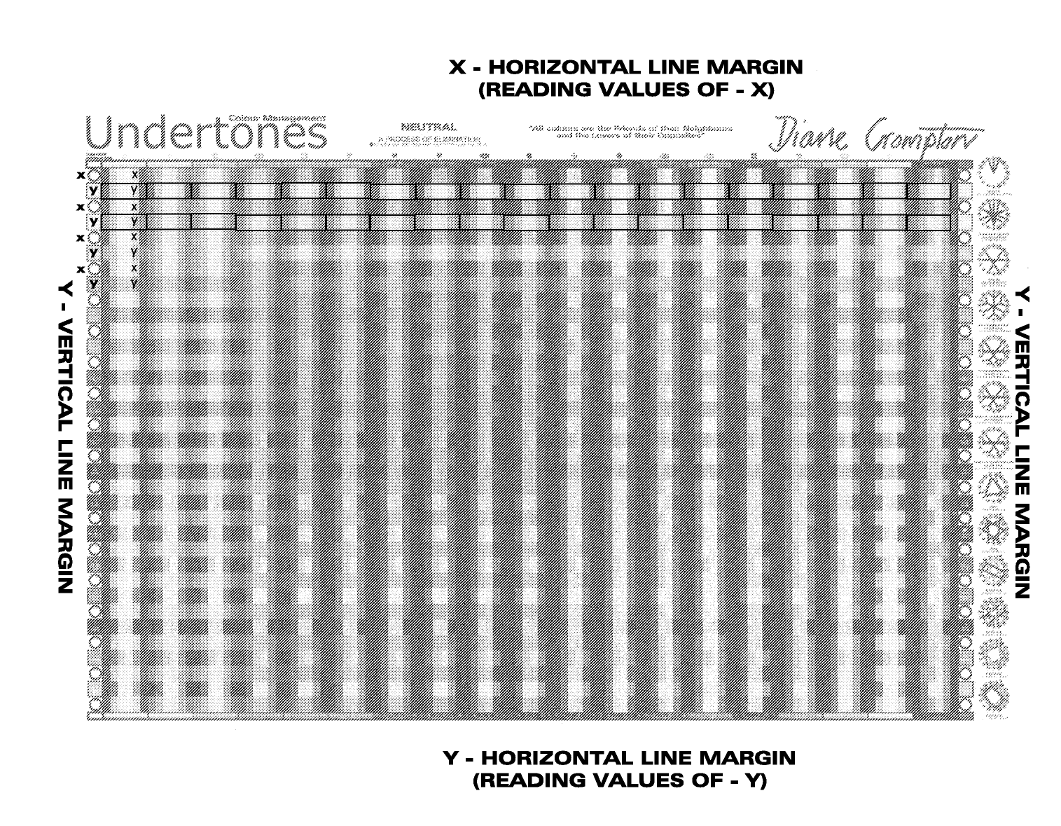

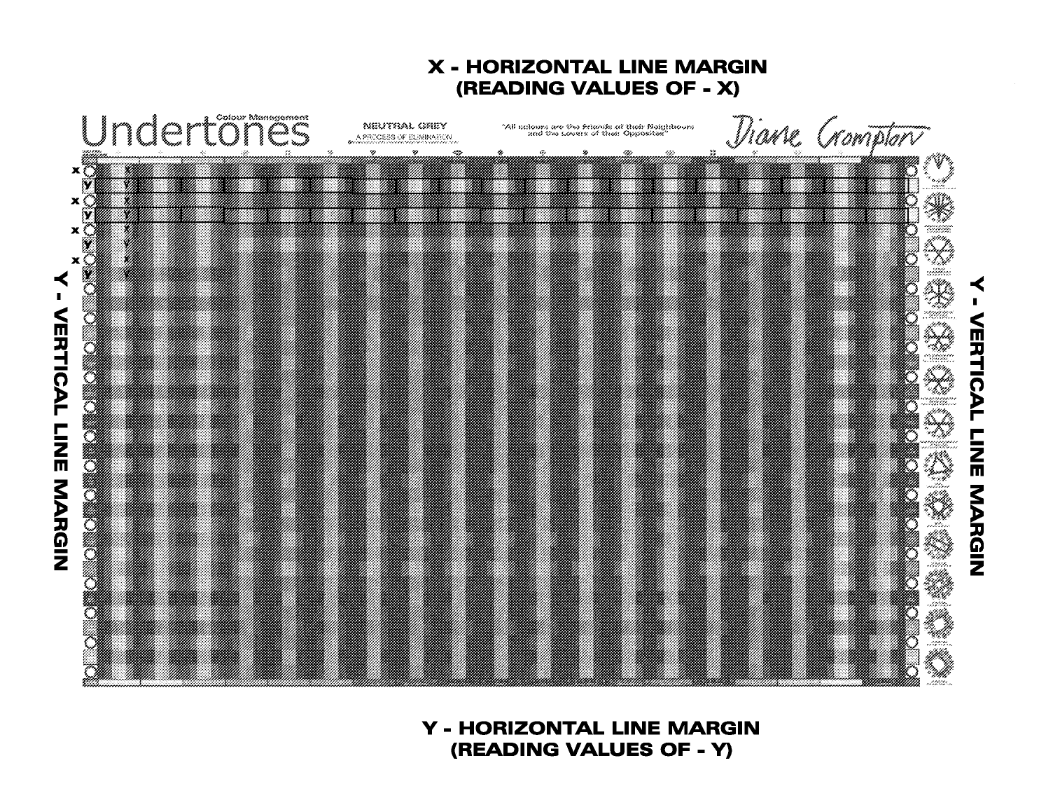

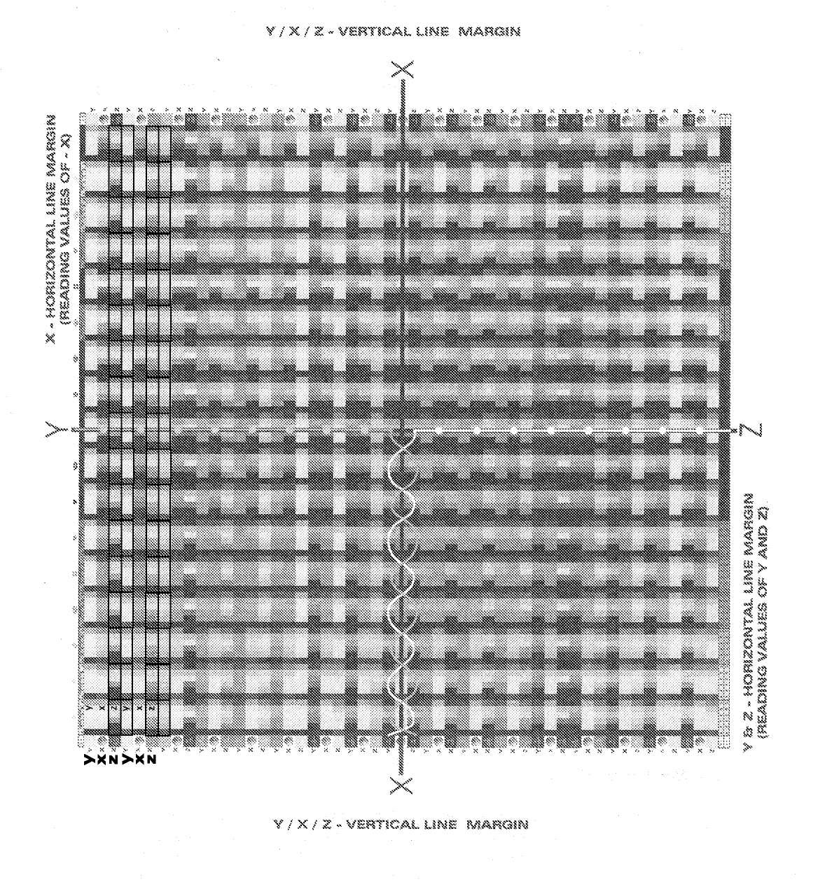

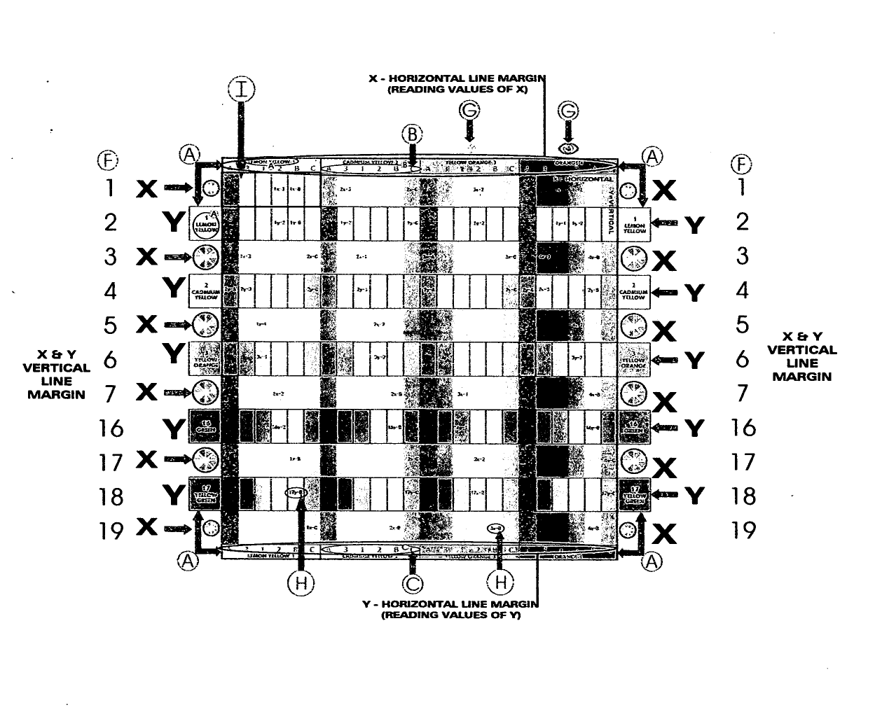

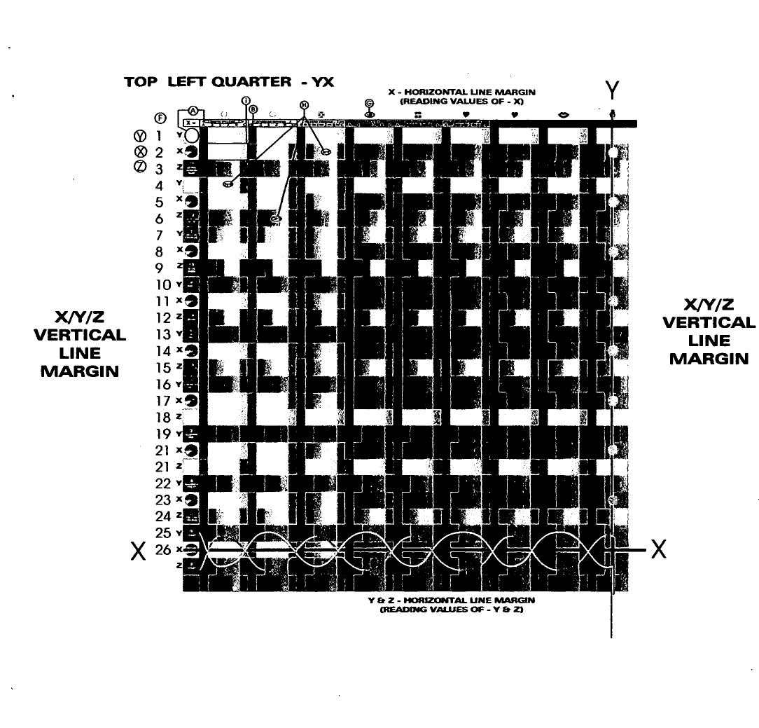

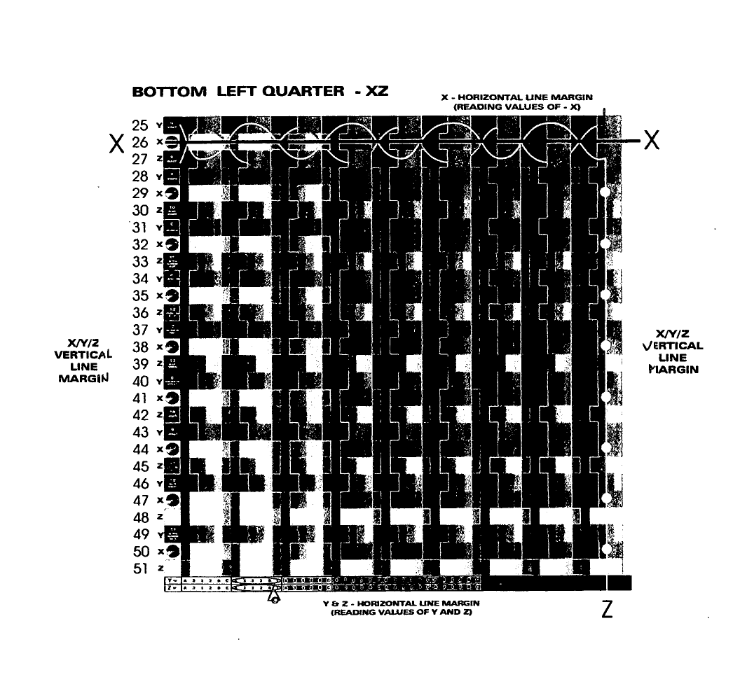

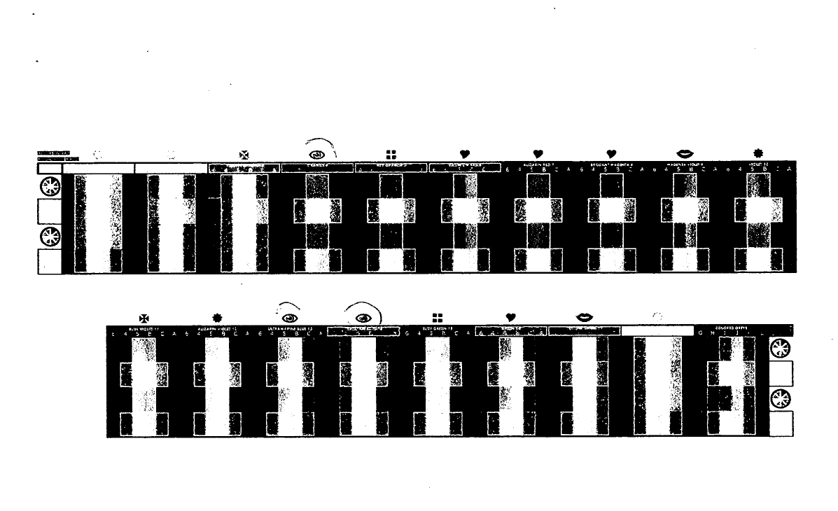

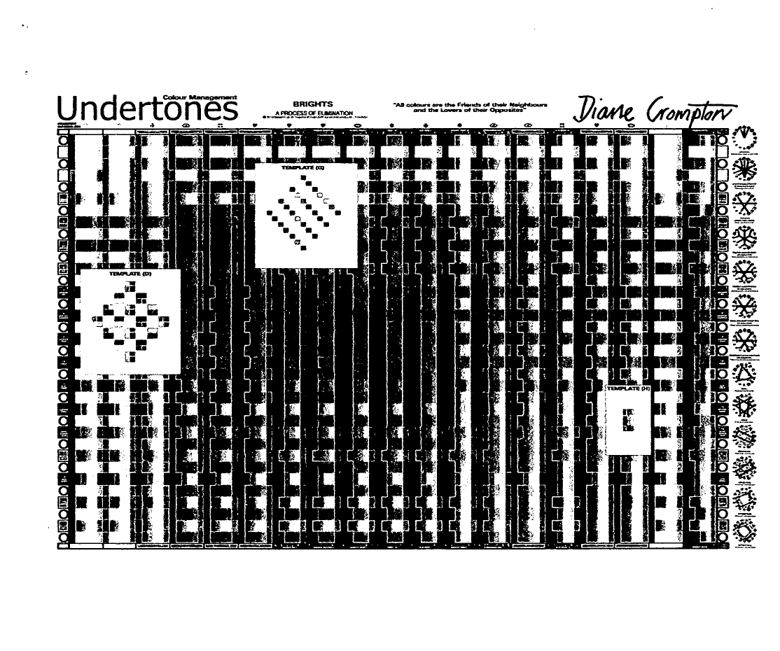

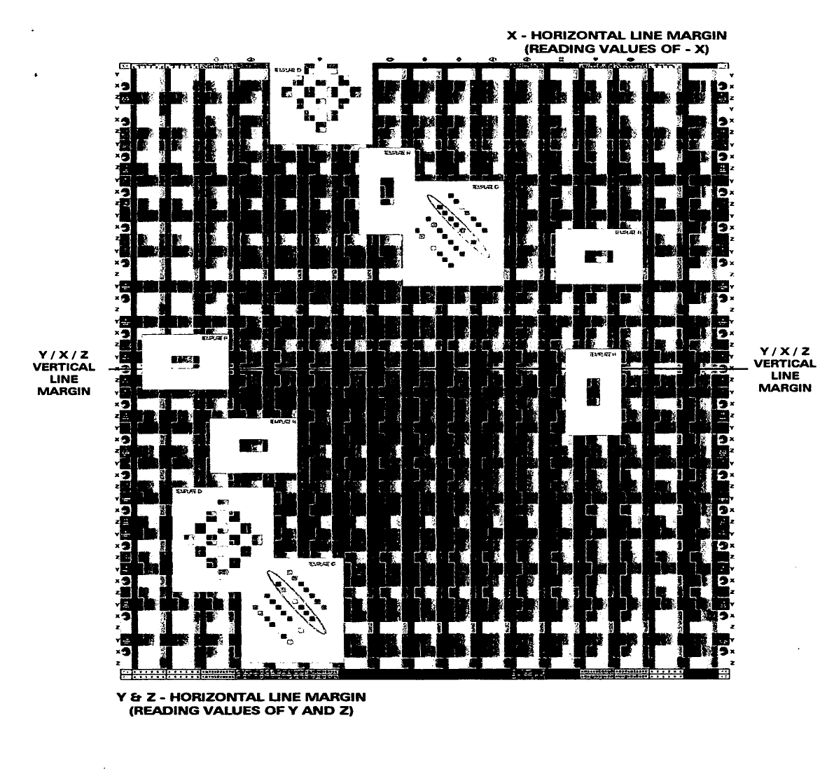

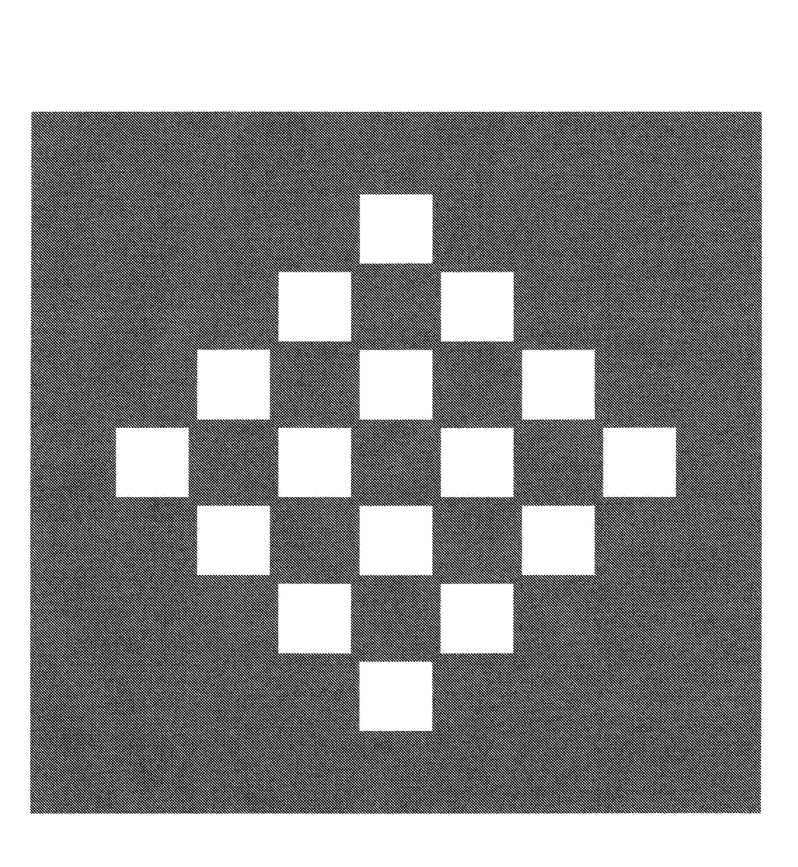

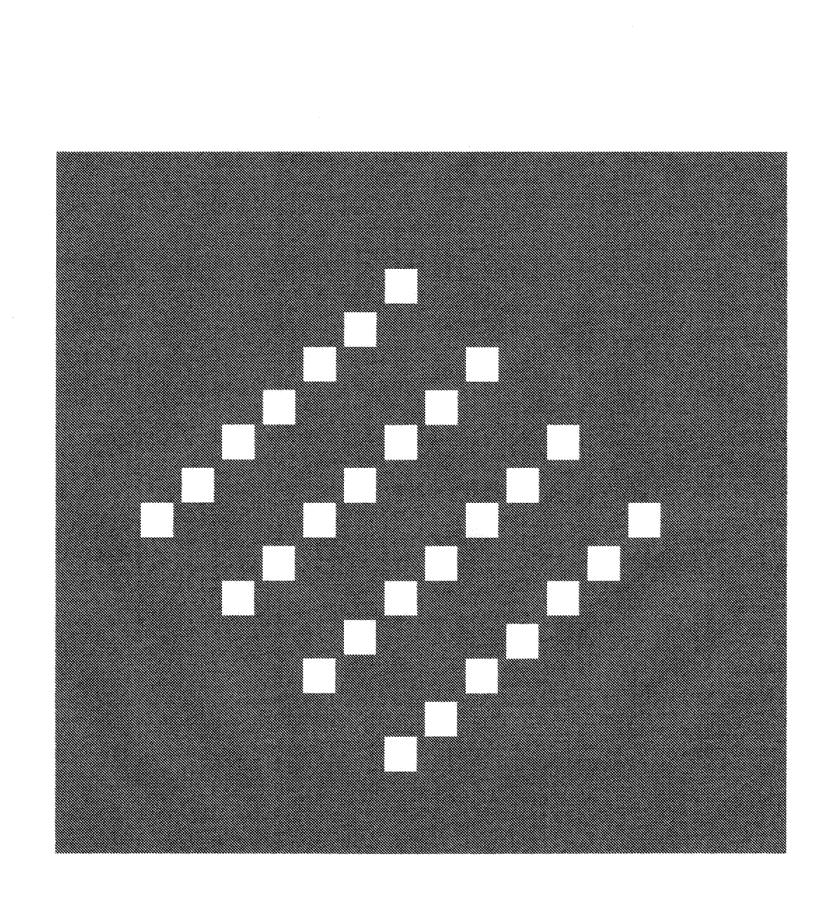

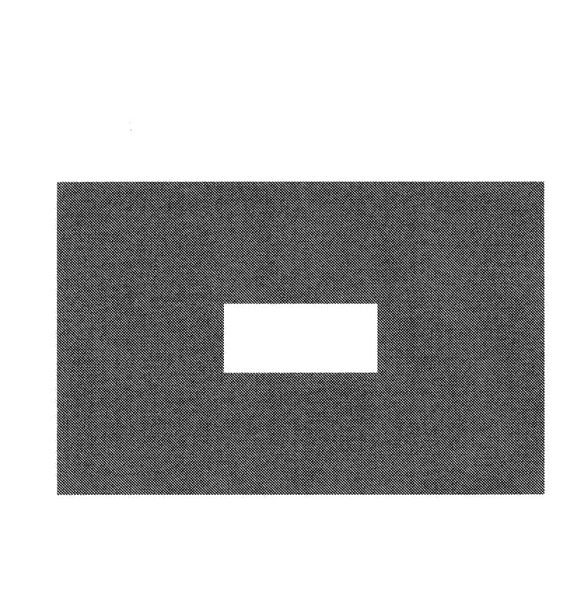

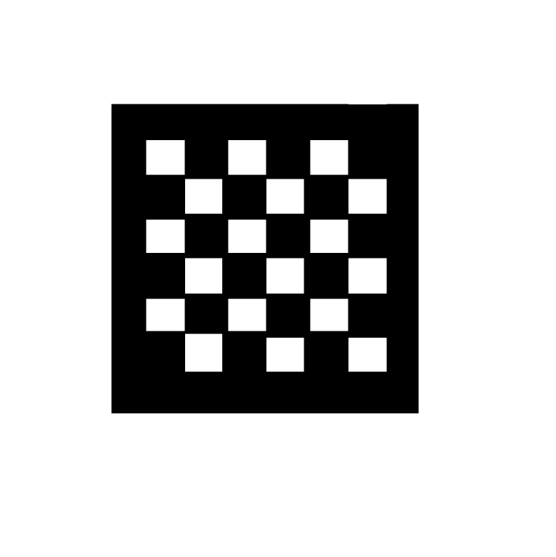

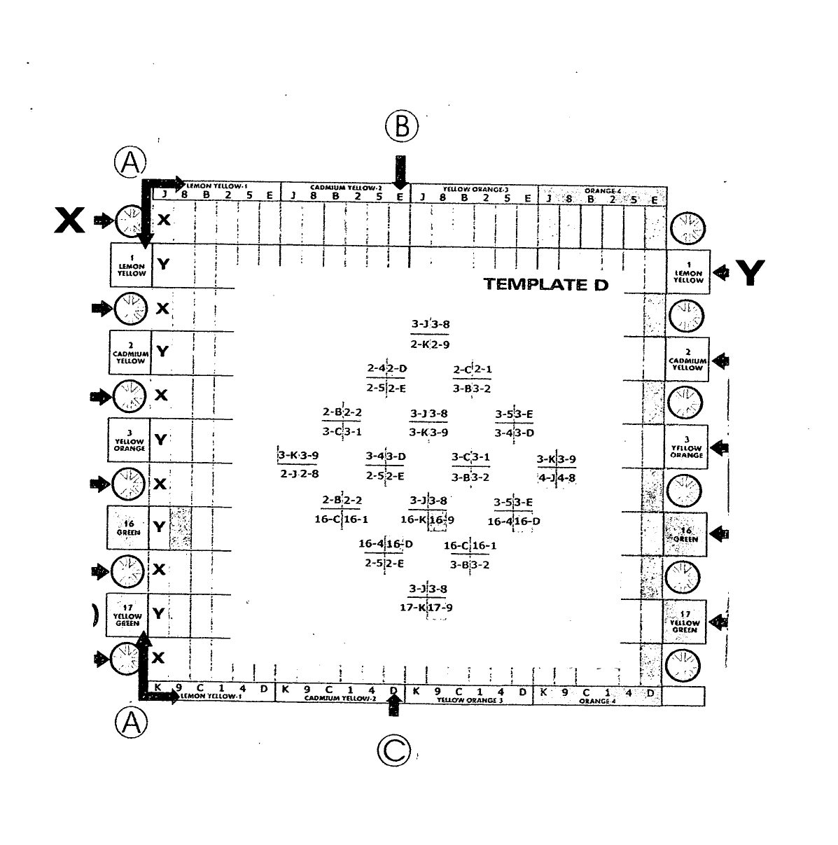

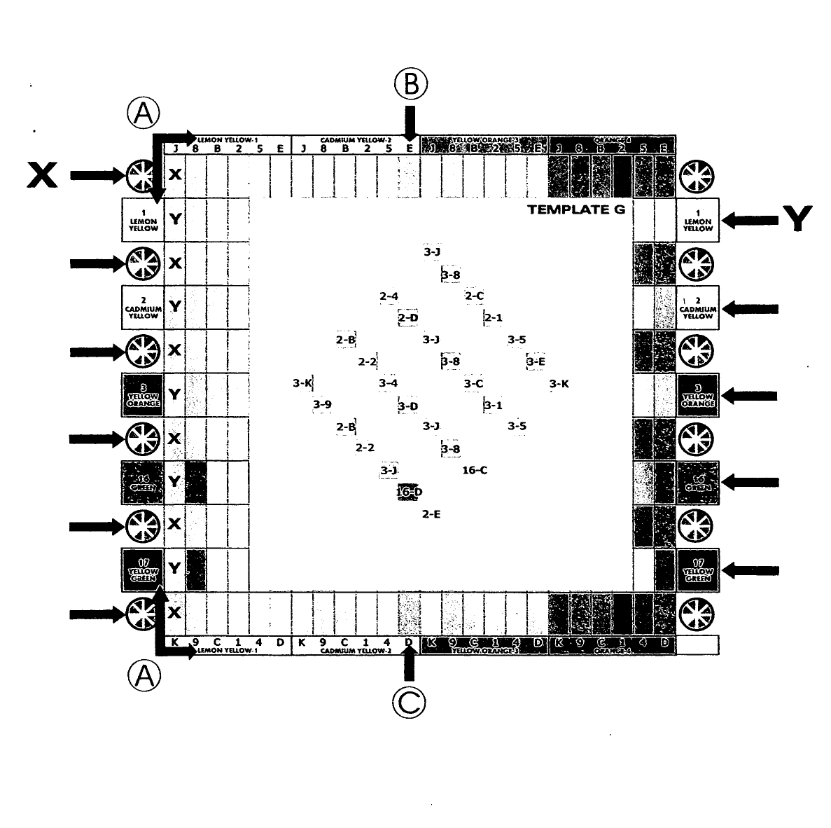

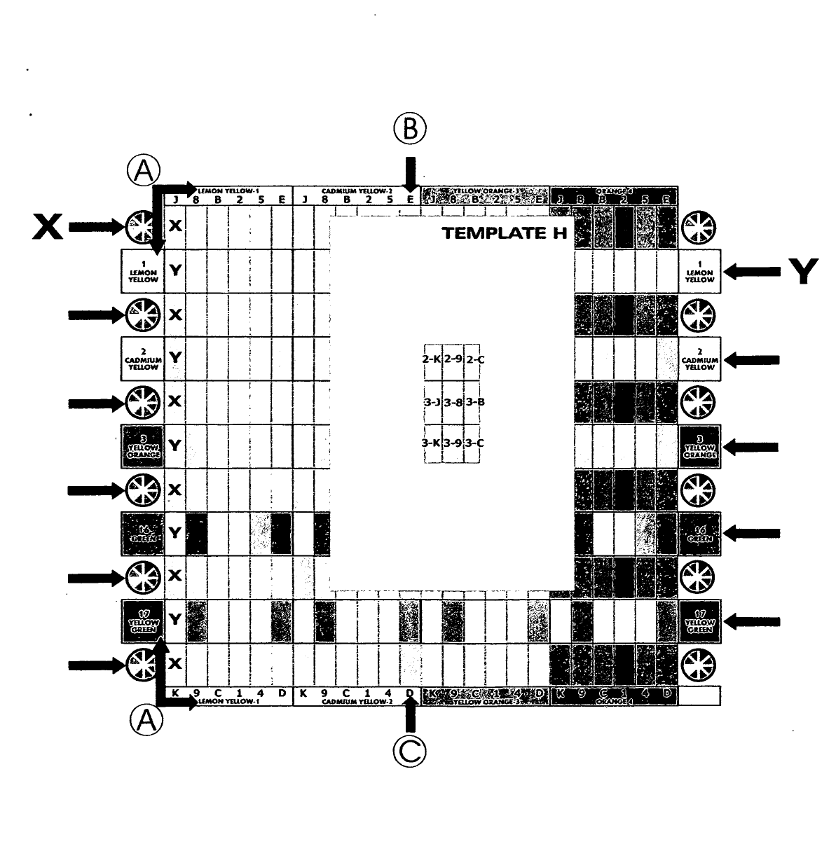

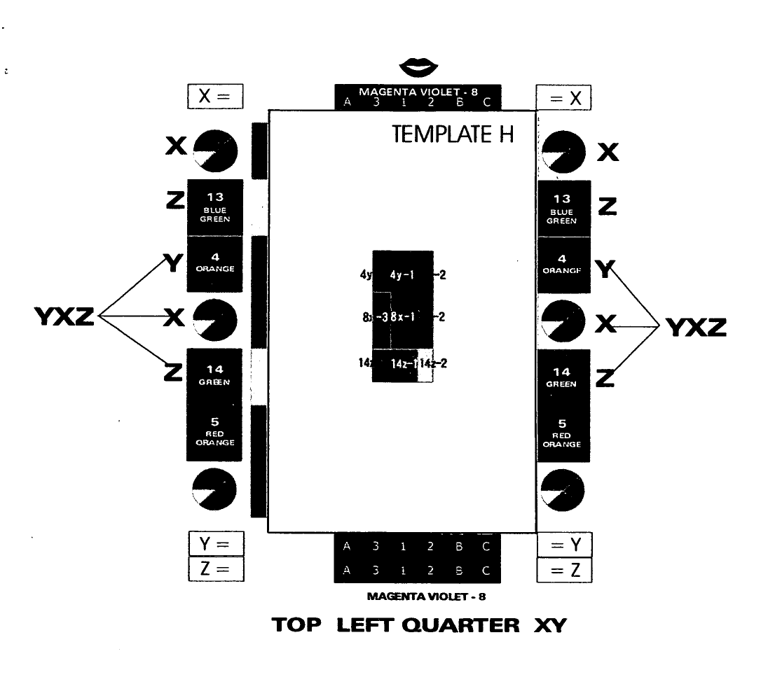

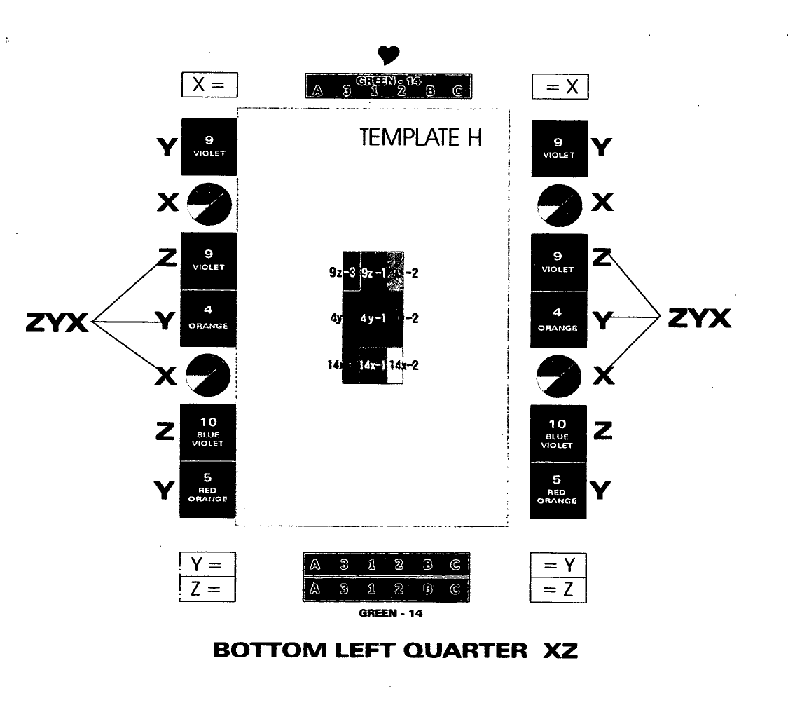

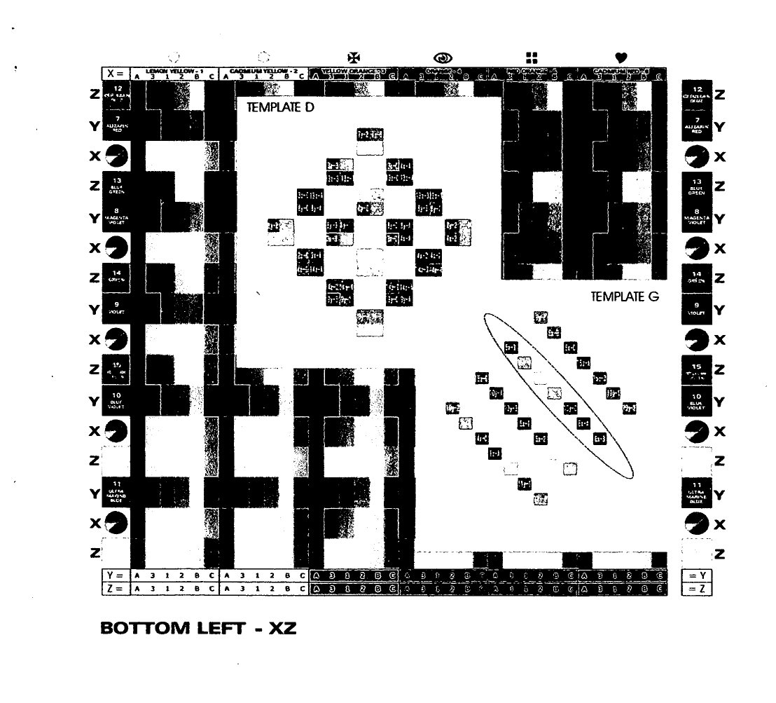

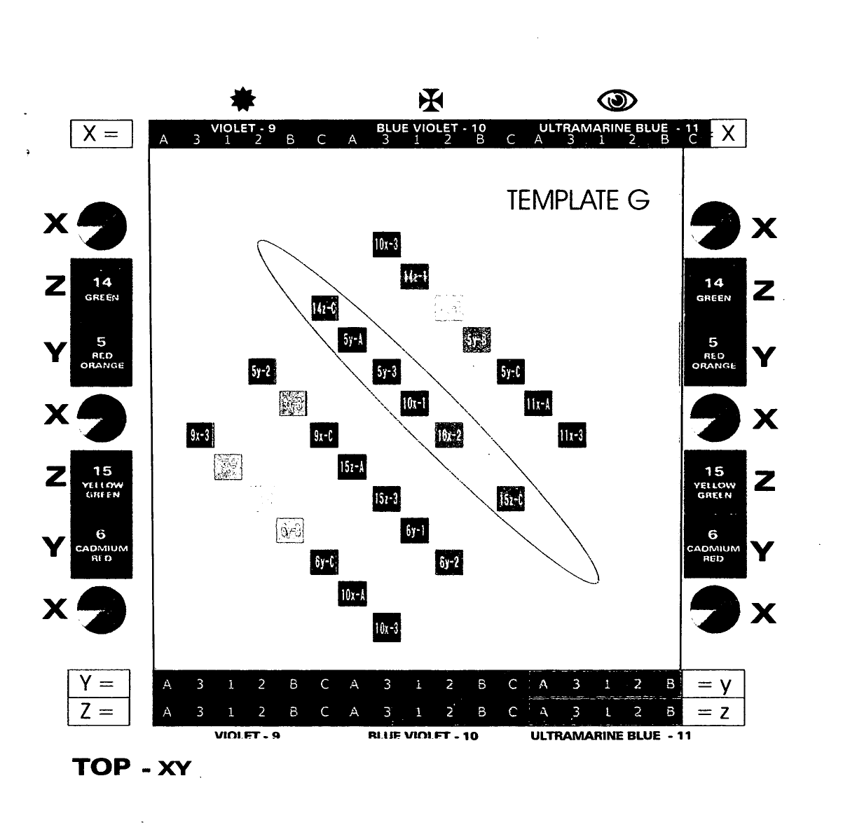

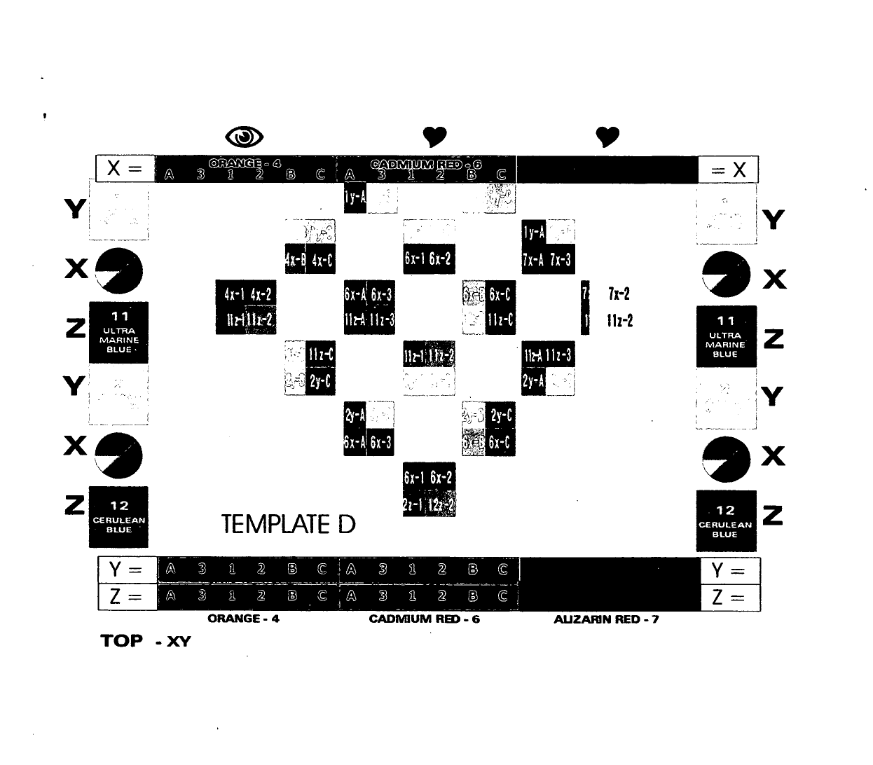

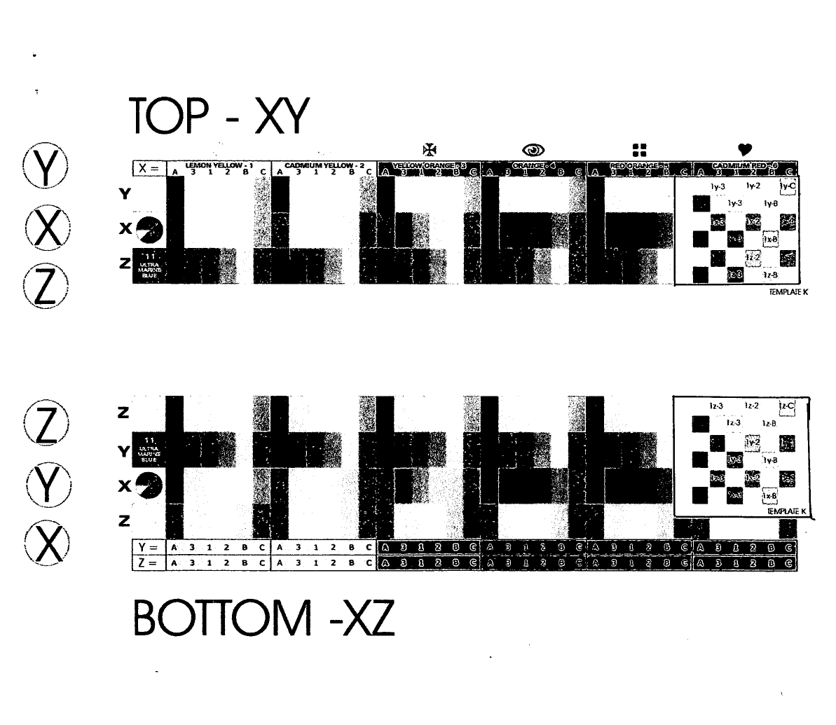

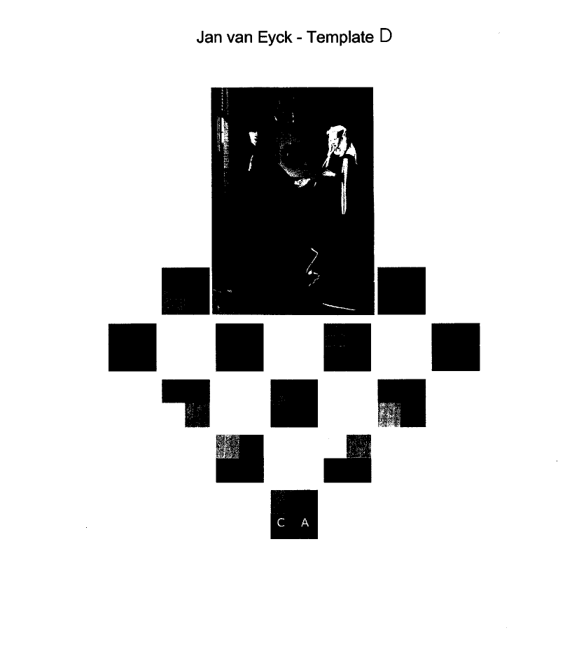

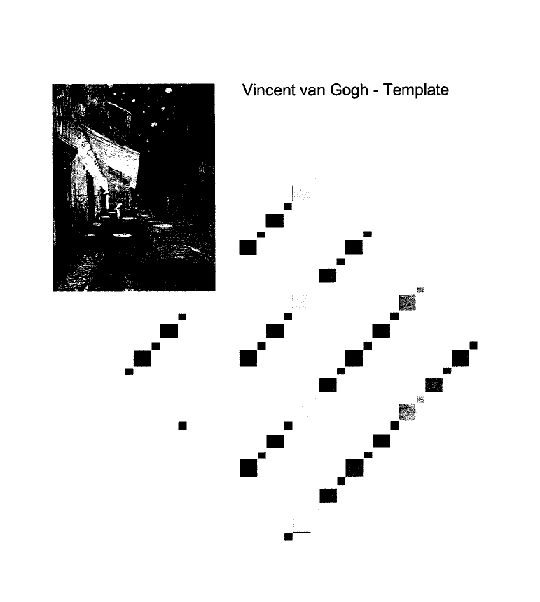

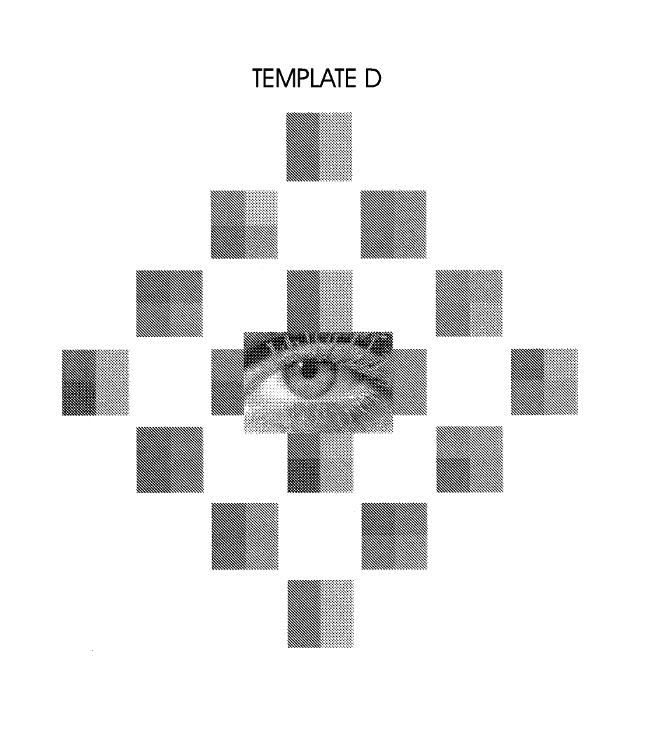

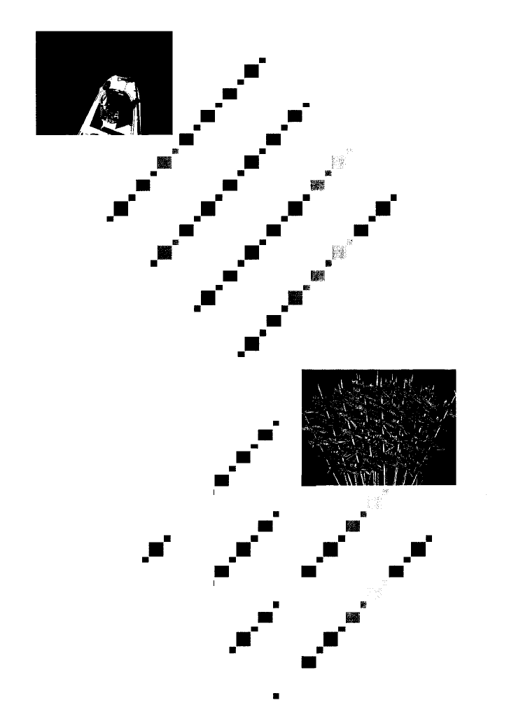

### CROSS-REFERENCES TO RELATED APPLICATIONS

The first Provisional application made in reference to this Colour Chart is Application Number 61/513,638 dated Oct. 5, 2011, named “Undertones Management Colour Chart” inventor Diane Margaret Crompton.

### TITLE OF INVENTION

The two Column and three Column Colour Chart (X/Y) and (YXZ) with structure, numbering and templates to be used as hardcopy and software: are used as a working visual tool which provide accurate colour information to the user: they are designed in a specific structured format based on a numerical value system and are used in conjunction with specifically designed templates. The 3 components (structure, numerical value system and templates) enable the user to accurately identify and select colour combinations, or cross-reference the identified colours to the many colour industry standards and specifications available globally. These components enable the system to be written and used in hardcopy or software formats. The Colour Charts highlight the connections between warm and cool colours, whilst offering the combinations of harmony, complementary, slit and near complementary, triad and tetrad solutions.

The research and development of the chart since this initial application has seen many significant advancements and improvements made to the design. This has led to the need to amend the design with the addition of templates, a numbering system, software and the implementation of features within the design. I would like to change the “title” of the colour charts to the title on the cover.

I have been advised telephonically (Ref number: 1-19532589) that I am able to introduce the templates and these changes in my Non-Provisional Application. The Drawing Diagrams have been submitted in colour, as my product is all about colour, I hoped by showing the colour it would enable a better understanding of the entire system. I have realised that it is impossible to specify the patent protection of only one colour chart as done in my first application, there are too many colour variations e.g. brights/neutrals/greys/lights/mediums and darks, so I would like ask to: replace the naming of exact colours with ‘a chronological sequence of the spectrum colours’ and hereby protect the structure and operation of the charts as discussed in the Specification. I would like to patent the protection of both Colour charts Design 1, 2, 3 (No. 1-3) and Design 4 (No. 4), however, in the case of any unforeseen circumstances, I would like to substitute Design 1 with Design 4 please.

Improvements: Design 1, 2, 3 (No. 1, 2, 3) EXAMPLES OF EXISTING 2 COLUMN COLOUR CHART

A chronological sequence of the spectrum colours (x), whilst not specifying what the exact colours are: running from left to right and duplicated from top to bottom of chart and alternating every second row with a family group row of colour (y). i.e. a duplication and pattern system: Spectrum line (x)

A repetition Line of a single Family group of colour (y), running from left to right and alternating with the Spectrum line(x) on every second row. i.e. a duplication and pattern system: Repetitive Family Group Line (y).

Showing each colours characteristics lying adjacent to every other colour on the Spectrum.

The addition of Templates D/G/H/K.

The addition of X and Y Horizontal Line Margins.

The Addition of X and Y Value co-ordinates.

Thus creating the addition of a Numbering system for each block of colour.

The additional information: To show harmony and complementary (+split and near) colour combinations lying adjacent to each other (without this charts structure, this would be impossible).

The ability to use one or two charts together e.g. Bright on bright/Bright and Neutral/Neutral and Greys etc. (too many charts to protect all of them).

For use in hardcopy and software.

This chart is unable to show Triad colour combinations.

IMPROVEMENTS: Design 4 (No. 4) IMPROVED 3 COLUMN COLOUR CHART

A design based on the structure of a protein molecule called Laminin. Diagram 16 (No. 28)

A chronological sequence of spectrum colours (x) whilst not specifying what the exact colours are: running from left to right and duplicated from to top to bottom of chart, alternating with every third Family Group Row of colour, separating Row Y and Row Z. i.e. a duplication and pattern system: Spectrum Line (x)

repetition line of a single Family group of colour (y), running from left to right and alternating with the Spectrum Line (x) on every third line, placing two repetitive family group rows (y) together, but each still lying adjacent to and separated by a Spectrum Row (x).

Showing each colours characteristics lying adjacent to every others colour in the Spectrum.

The addition of Templates D/G/H/K.

The addition of a X Horizontal Line Margins (top)

The addition of a Y&Z Horizontal Line Margin (bottom)

The addition of X/Y and Z Value co-ordinates.

Thus creating the addition of a Numbering system for each block of colour.

The additional: To show Harmony/complementary (split and near), Triad colour and Tetrad combinations lying adjacent to each other (again impossible without the structure).

The ability to use one, two or three colour charts together e.g. Bright/Bright and Neutrals/or Bright, Neutral and Grey.

For use in Hardcopy or Software

### OTHER APPLICATIONS

WIPO—The Hague Agreement: DM/077000 Diagram 17 (No. 29)

Intellectual Property of New Zealand: Registered Design No. 414573 Diagram 18 (No. 30)

Intellectual Property of Australia: Registration AU 336483 S Registered Design No 201111286 Diagram 19 (No. 31)

### STATEMENT REGARDING FEDERALLY SPONSERED RESEARCH OR DEVELOPMENT

“Not Applicable”

### THE NAMES OF THE PARTIES TO A JOINT RESEARCH AGREEMENT

“Not Applicable”

### INCORPORATION-BY-REFERENCE OF MATERIAL SUBMITTED ON A COMPACT DISC

“Not Applicable”

### BACKGROUND OF THE INVENTION

1. Field of the Invention

The Colour Chart is designed as a means of identifying colours and their relationships to each other and any other type of colour chart. See definitions below:

“Class 434-98. Color Display: This subclass is indented under subclass 81. Subject matter relating to a means for showing color or presenting color characteristics, e.g., a chart naming harmonious colors and complementary.”

Class 104-104. Including relatively rotatable elements (e.g., concentrically mounted color disks, etc.): This subclass is indented under subclass 98. Subject matter including parts which turn relative to each other.” (Templates can rotate)

Class 717, Data Processing: Software development, installation and management.

2. Description of the Related Art

There are many standard ways of displaying and viewing colour: The colour wheel, a Graph format with a Spectrum of colour running from top left corner and ending in the bottom right corner, these can be seen in hardcopy posters or in software designer programs. There are fan decks in a booklet display, or circular ball format. None of these systems reveal: All the colours in the spectrum lying adjacent to EACH colour in the spectrum, revealing each colours relationship to one another, as every colour affects and influences the colour beside it. The Colour Charts unique layout reflects these relationships of colour to each other and with the combination of the use of templates and a numerical system provide valuable information. I knew that my system could prove the colour thinking used by the Old Master Painters from the 12th Century (Middle Ages), e.g. Giotto through to the 21^{st} Century and beyond. See Diagram 12, 13 (No. 24-25). These artists learned from nature and therefore the charts could depict nature: See Diagram 14, 15 (No. 26-27). I have never witnessed any previous chart designs which make use of this concept to provide colour solutions and information depicting the past, present and future, which has been purely achieved by the repetitive layout structure of the charts provided here.

### SUMMARY OF THE INVENTION

The Colour Chart has been designed as a working tool, to provide accurate colour information to the user when used in conjunction with the templates provided. The colours have been mixed to specific formulae's and are shown as a spectrum identified in a chronological sequence. The system provides the user with the necessary tools to accurately identify and cross-reference colours. The colour sequencing and their layout are made in a specific and repetitive format. This concept creates the unique visualisation process which enables each colour within the spectrum to be independently viewed alongside the other colours of the spectrum, thereby revealing their characteristics, relationships and influences on each other. The templates reveal colour combinations in varying temperatures as they compete for attention with one another.

Design 1, 2, 3: (No. 1-3)

X=Represents the Spectrum Line-represented by an icon the colour wheel.

Y=Represents each repetitive family group of values within the spectrum-represented by a name and number

X=The spectrum line is duplicated and alternated with Y from the top to the bottom of the chart (or visa versa).

Y=Each family group of values are duplicated across the horizontal length and alternated with X (or visa versa)

X=Numbering System read on the X Horizontal Line Margin

Y=Numbering System read on the Y Horizontal Line Margin

This enables us to view colour relationships lying next to each other in harmony or to view colours opposite to each other called complementary and those lying either side of the complementary called split or near complementary viewed with the use of the templates. All colours have independent numbers and can be used for software or any other colour applications.

Design 4: (No. 4)

X=Represents the Spectrum Line-represented by an icon the colour wheel.

Y=Represents the repetitive family group of values within the spectrum-represented by name and number.

Z=Represents the repetitive family group of values within the spectrum-represented by name and number.

X=The spectrum line is duplicated and placed between Y and Z separating them. It is placed on every 3rd row.

Y=Begins at the top of the chart and works down (these can be begin in any order of the spectrum).

Z=Begins at the bottom of the chart and works up (these can begin in any order in the spectrum).

X=Numbering system read on the X Horizontal Line Margin

Y & Z=Read on the Y & Z Horizontal Line Margin

In the centre: Violet No 9. takes on a Y and Z Value which creates different readings in the top right hand quarter (XY) and the bottom left hand quarter (XZ) this proves that both quarters are very different structures. It also proves that (Y can live in X), and (Z can live in X) as both can be read using the Y & Z Horizontal Margin.

Although different they work together to bind and hold a system together as in a Protein Molecule Structure. See Diagram 16 (No. 28). All colours have independent numbers which can be used for software or any other colour applications.

### BRIEF DESCRIPTION OF THE SEVERAL VIEWS OF THE DRAWING(S)

Please note: Wherever I have used a description of a name, number or letter, it could be replaced with any reference description i.e. an icon, or pattern, alphabetical letter, paint name or number.

DIAGRAM: 1A, 4A and 4B (No. 5-7)—Cross Section of the Colour Charts

Margin A: These are the top and bottom Horizontal Line Margins and the left and right Vertical Line Margins giving reference to the Identification Points of the chronological spectrum of colours of the chart.

B: These are groups of colours located within the Upper A-Margin and are used for reading the value of X, they have an individual code for each designated family group of colour which is repeated the full length from left to right.

C: These are a group of colours located with the Lower A-Margin and are used for reading the values of Y and Z, they have an individual code for each designated family group of colour, which is repeated the full length from left to right. The only difference in Sector C is when there is an introduction of new colours, one, two or three which would mean a different set of individual codes would be given. i.e. Bright Y=(A312BC) can change to Neutral Y=(J8B25E) or Grey Z=(K9C14D)

F: Represent the Row Numbers, this is used here for explanation and recording purposes e.g. The spectrum row X=1,3,5,7,9,11,13,15 etc. while Repetitive row Y=2,4,6,8,10,12,14, in Design 1. Or vice versa) and in Design 4. Spectrum Row X=2,5,8,11,14,17,20,23,26,29,32,35,38,41,44,47,50 while the Repetitive Row Y=1,4,7,10,13,16,19,22,25,28,31,34,37,40,43,46,48,49 AND Repetitive Row Z=3,6,9,12,15,18,21,24,27,30,33,36,39,42,45,48,1. (These can all run in any sequence, but must be in a chronological order).

G=These are symbols which I have used to represent Complementary Colours (Opposites) also any type of name/number/alphabetical letter etc. could be used to represent this. Diagram 5 (No. 8).

X=Represents the spectrum row and is read on the X-Horizontal Line Margin.

Y=Represents the Repetitive Family Group Row and is read on the Y or on the Y & Z Horizontal Line Margin

Z=Represents the Repetitive Family Group Row and is read on the Y & Z Horizontal Line Margin.

H=By using a repetitive sequence and alternating process allows for a unique numbering system for colour viewing and application (x or y or z), H shows us how to take a reading, while every colour block has a designated code number. It is this system which makes it possible for software programs or combining this system with many other Global Standard colour applications e.g. Pantone, RGB, Hex etc. and other Manufacturers working with colour products.

I=Shows a family grouping of colours in their variation of values of a single colour (outlined) i.e. Lemon Yellow etc.

Drawings of Templates: Diagram 6 and 7 (No. 9-10)

The operation of templates on the colour charts, here you see how they can be moved around the chart, showing colour combinations by means of the open cut-out windows.

In the case of software the actual computer screen becomes the template, with charts all laid beneath the surface.

Diagram 8, 9, 10, 11 (No. 11-14) show the actual dimensions of the specifically designed templates.

Diagram 6A, 6B and 6C (No. 15-17) and Diagram 7A, 7B, 7C, 7D, 7E, 7F (No. 18-23) show how we can read the Y, X and Z values on Template D/G/H/K on the top, while Y, Y And X values are read on the bottom. This product can be a hardcopy wall chart with these “open cut-out windows” templates revealing various proportions, temperatures, densities and variations in colour relationships, offering harmony and complementary, triad and tetrad solutions in one, two, three or four colours.

In Template H, Diagram 6C (No. 17) the Number 3-8 is surrounded by Numbers 2-K,2-9,2-C,3-B,3-C,3-9, 3-K and 3-J these co-ordinates of each chart are programmed in and revealed through any window frame and can be called up any time by the use of number programming revealing cross sections of these colours or colours from other charts. In the i-Pad Application the template would be the computer screen with ones finger moving across the screen, showing all possible positioning of the templates on top of the charts beneath, limitless in the amount of colours used but each colour synchronised and linked by numbers to all the other Global International Reference Products.

### SPECIFICATION

This Colour Chart has been designed as a spectrum of colour placed in a chronological sequence.

This spectrum is broken down into corresponding colour values belonging to each family group of colours i.e. the first 6 blocks of a row, these colour values are repeated in their groups throughout the length of the chart. These values named x are read only on the Upper X-Horizontal Line Margin.

The Y-Horizontal values can be the same numbers or different numbers as on the Upper X-Horizontal Line Margin, but would change if a new colour was added to this line. The named y and z values of both charts are read on the bottom Horizontal Line Margin.

The spectrum (x) begins on the top row which is then duplicated in every odd number row. The family groups of colours (y) are also duplicated in every even number row, except in the new chart, whereby a new family group of colours is introduced (z) and each operates on every third row, the spectrum (x) separating (y and Z) at certain intervals.

To establish the individual codes of each colour we see how on the Y-Vertical Line Margin Identification Number, 16 Green, intersects with the Lower Y-Horizontal Line Margin Identification Number, 1. The resultant intersecting cell is 16-1, which is the identifying code for the colour.

This concept creates the unique visualisation process which enables each colour in the spectrum to be independently viewed alongside all the other colours of the spectrum, thereby revealing their characteristics, relationships and influences on each other. Other colours can be introduced by working on the same repetitive system in the Y-Rows. A third set of colours can be added, e.g Z-Row, which will still be read on the Y-Horizontal axis. These rows are also able to be operated in reverse which will allow the process to still be effective. This is due to the spectrum of colours still able to be viewed adjacent to a line of repetitive colours.

With the use of the layout of the colour chart and by incorporating the numbering system and templates, it allows for a tangible product to be placed into a computer software format for Computer programming, computer Applications and computer downloads. The layout of the chart

incorporated with the operation of the templates allow for consolidated areas of colour to be viewed through the cut out areas, hence revealing startling working relationships of colours for all types and levels of Designers and Manufacturers working in the Colour Industry.

The open windows on Templates D, G, H and K (are all given their own numbers which when placed anywhere on the charts, gives colour combinations and choices (novel, new and operational) in the manner in which colour can be presented. Understood and applied.

An additional unique opportunity for using this colour numbering system allows for the convenience of other colour systems to be incorporated into it: The colour and numbering on the charts can be linked to other types of substrates for the Manufacturing Industry using their own unique codes, names or numbers ie. Paint for paint manufacturers, Ink for Ink Manufacturers, Cottons and Thread, Plastics, Fabrics or Wall Paper Manufacturers, absolutely anyone manufacturing and working with colour. Global International Standards of Colour can also be linked to the numbers on the charts by using the charts colours and numbers and linking them to Codes for: Pantone colours (printing) RGB colours (computer industry), Hex colours (web sites and gaming industry), as can be seen in Diagram 6B. (No. 16)-Template (G) the number 3-J=Pantone 1006=RGB 514=Hex 95585 (Example Only) and in Diagram 7D (No. 21) 10-3=Pantone 4223=RGB 987=Hex 98862

A novel concept for colour application, colour planning and colour visualisation and a novel aspect of Industrial Design. Everyone working with colour is at different levels of understanding this dynamic approach can assist others whether in hardware or software. The chart has been specifically designed for the Interior, Fashion, Industrial, Textile and Graphic Designers Industry, Arts, Crafts, Hobbies, Educational Institutions, Colour Consultants, Architects and all businesses dealing with colour manufacturing and the sales of colour to customers and particularly for the Secondary and Tertiary Education Sector.

There are too many colours in the universe to protect everyone and every system; however this system is an original working piece of Intellectual Property, allowing the ease, convenience and understanding of colour relationships for people at all various levels of thinking. Its unique format, allows us to mimic the use of colours as seen in nature surrounding us and artists in history.

The well thought out relationships of colours and systems all for colours to be shown in various proportions and relationships i.e. harmony, complementary, split complementary and near complementary, triads and tetrads which includes the freedom of choice for funky or discordant relationships of colours for the end users to choose.

Every wall colour chart comes with a book which includes all the artists paint recipes and every colour recipe is corresponding with a number on the charts, the same number linked to Pantone, RGB and Hex codes replicating similar colours. The recipe book will be sold individually and on-line, all linked to a Website where tangible charts (including hardcopy of book) can be ordered and posted to clients around the world.

The Website will include an option for a “download” of charts for a personal computer while an Apple Mac download Application will be specifically written in Mac language to be sold in the Apple i-Store which will also include all paint Recipes, Pantone, RGB and Hex Codes linked by numbers to colours on the chart. The beauty of the colour chart when written in a software format allows you to use as many charts on top of each other at once and through the numbers and programming can be viewed individually or simultaneously at once. The template cut outs will show one chart eg. Bright, but an option will allow you to incorporate and view other colours, but in grey or neutral at the same time as viewing the bright.

The wall charts will be printed in AO size in process print using CMYK, as discussed a book will accompany each chart, also printed in CMYK. Templates will either be laser cut from thin plastic or die cut from magnetic vinyl allowing for a smooth operation for end users. Magnetic paint is readily available, where a wall or board can be coated, the chart adhered to and the magnetic templates will be operational. Templates windows can be cut out in any shape squares, circles, stars, rectangles etc.

Part of my marketing research has been to visit Interior, Fashion, Textile, Graphic Designers and Artists in Hawkes Bay, New Zealand, nobody has seen a product of this nature and all have requested orders, however, I will only manufacture when patents are in place. I have approached a recognised Paint Manufacturer operating throughout Australasia. In response to my hardcopy version, their feedback was, “this is a highly Intellectual and Philosophical Product.” They have requested their colours be put into my chart for all their showrooms and gifts Architects.

Design 1, 2, 3 (No. 1, 2, 3) COLOUR CHART WITH 2 COLUMNS

1. A chronological sequence of the spectrum colours (x), whilst not specifying what the exact colours are: running from left to right and duplicated from top to bottom of chart and alternating every second row with a family group row of colour (y). i.e. a duplication and pattern system: Spectrum line (x)
A repetition Line of a single Family group of colour (y), running from left to right and alternating with the Spectrum line(x) on every second row. I.e. a duplication and pattern system: Repetitive Family Group Line (y). This showing each Spectrum colour lying adjacent to every other colour of the spectrum revealing each colours characteristic against one another other.
The addition of Templates D/G/H and K with X and Y Value co-ordinates, creating a Numbering system for each block of colour which can be used to incorporate Global systems.
To show harmony and complementary (+split and near) colour combinations without the repetitive sequence of colouring this numbering and colour relationship would not be possible to be achieved and used in hardcopy and software.
Design 4 (No. 4) COLOUR CHART WITH THREE COLUMNS
A design based on the structure of a protein adhesion molecule called Laminin.
A chronological sequence of spectrum colours (x) whilst not specifying what the exact colours are: running from left to right and duplicated from to top to bottom of chart, alternating with every third Family Group Row of colour, separating Row Y and Row Z. i.e. a duplication and pattern system: Spectrum Line (x)
A repetition line of a single Family group of colour (y), running from left to right and alternating with the Spectrum Line (x) on every third line, placing two repetitive family group rows (y) together, but each still lying adjacent to and separated by a Spectrum Row (x). This shows each Spectrum colour lying adjacent to every other colour of the spectrum revealing each colours characteristics against each other.
The addition of Templates D/G/H/K and Y/X and Z value co-ordinates creating a Numbering system for each block of colour which can be used to incorporate Global Systems.
To show Harmony/complementary (split and near), Triad and Tetrad colour combinations without the Repetitive sequences of colouring this numbering and colour relationship would not be possible to be achieved and used in Hardcopy or Software.
